(19) United States
(12) Patent Application Publication
(10) Pub. No.: US 2024/0092096 A1
(43) Pub. Date: Mar. 21, 2024

(54) METHOD AND APPARATUS FOR PRINTING A SURFACE OF A PAPER

(71) Applicant: SWISS KRONO Tec AG, Luzern (CH)

(72) Inventors: Sabrina PFEIFFER, Kyritz (DE); Falko GEITZ, Zernitz-Lohm (DE); Frank OLDORFF, Schwerin (DE)

(21) Appl. No.: 18/254,988

(22) PCT Filed: Dec. 1, 2021
(86) PCT No.: PCT/EP2021/083789

§ 371 Date: May 30, 2023

(30) Foreign Application Priority Data
Dec. 3, 2020 (EP) 20211507.7

(51) Int. Cl. B41J 11/00; B41J 3/407; B41M 5/00

(52) U.S. Cl. CPC B41J 11/00212; B41J 3/407; B41J 11/00216; B41M 5/0017

(57) ABSTRACT

The disclosure relates to a method for printing a decorative pattern onto a surface of a paper that includes: applying a primer to a surface of an unprinted base paper, printing a grid marking and a decorative pattern onto a primer-coated base paper, thereby obtaining a printed base paper, detecting a grid spacing between at least two points of the grid marking to determine an actual state of the printed base paper, comparing the detected grid spacing according to the actual state with a grid spacing digitally stored as a target state for the printed decorative pattern, amending the stored target grid spacing based on the comparison by creating an amended target grid spacing and a decorative pattern amended therewith and/or amending at least one process parameter for controlling the application of the primer and/or the printing of the grid marking and/or the drying until a predetermined criterion is met.

### FIELD OF INVENTION

The invention relates to a method for printing a decorative pattern onto a surface of a paper by means of a digital printing facility that comprises at least one primer application unit for applying a primer, at least one printing unit for printing the decorative pattern onto the applied primer and at least one dryer for drying at least one part of the paper once the primer and/or the decorative pattern have been applied. The invention also relates to a method for printing a decorative pattern onto a surface of a paper by means of a digital printing facility that comprises at least one printing unit for printing the decorative pattern onto the applied primer and at least one dryer for drying at least one part of the paper once the primer and/or the decorative pattern have been applied. The invention also relates to a digital printing facility for conducting such a method.

### BACKGROUND OF INVENTION

Nowadays, decorative patterns are printed onto the surface of paper in a range of applications and for various purposes. In the present case, a decorative pattern is understood in particular to mean a graphic, especially a pictorial, representation which should change the visual impression made by the paper. The paper may be provided in the form of individual sheets or in the form of a roll. If the paper is printed in the form of a roll, it is preferably cut to the correct size required for the application after printing.

The use of a digital printing facility for printing the surface of a paper has a number of advantages. For example, it is very quick and easy to switch from one decorative pattern to another. There is no need to remove or exchange any rollers or similar elements, meaning that conversion times are very short. Here, the paper is clamped into the digital printing facility and held at the right tension by rollers. Wrinkle formation is to be prevented at all costs if a clean printed image is to be generated and the amount of waste is to be kept to a minimum.

It is known that in web printing, a change in the dimensions of the paper web to be printed can occur during the printing process. This may occur due to the tension at which the paper web is held in the printing facility, which causes the paper web to expand in the direction of transport, also known as the running direction. In the case of highly colored decorative patterns in particular, where a relatively large amount of ink is applied in liquid form to the paper web to be printed, a so-called wet expansion of the paper may occur. It is known that moist or even wet paper expands. This usually occurs more strongly transversely to the running direction than in the running direction. Different grammages of paper, irregularities and deviations in paper production and/or the colors used can also mean that the base papers to be printed are first coated with a primer coating, the so-called primer. This produces a uniform, reproducible and pre-determined base color of the papers to be printed. Like the printing inks, the primer is mostly provided in liquid form, so that the volume in which it is applied can also lead to wet expansion of the paper. The moisture of the base paper, which can be determined or at least influenced, for example, by the humidity in the room in which the paper is stored, can impact the expansion of the paper.

In particular, the moisture of the paper which, as previously explained, can be influenced by the ink or the primer, also depends at a given moisture level on how effectively and how heavily the applied liquid can penetrate into the respective paper. This can be influenced by aggregates which, for example, are added to the base paper during production, or by the production method of the base paper.

A digital printing facility of the type described here therefore has at least one dryer by means of which at least one part of the surface to printed, but preferably the entire surface to be printed, can be dried. This is achieved, for example, by subjecting the surface to an air flow, in particular a warm air flow, or irradiating it with heat or infrared radiation. Such drying can take place at various points during the method. Preferably, the digital printing facility has at least two dryers, one of which is arranged downstream of the primer application unit in the process direction and the other downstream of the printing unit. As a result, it is possible to dry the paper after applying the primer and after printing the grid markings and the at least one decorative pattern. In both application steps, in addition to the actual effective substances, water is also introduced, which has an effect on the non-resined base paper.

Preferably, any potential paper expansion, especially in the running direction, can be stopped by adjusting the tension applied by the guide rollers of the digital printing facility. The disadvantage is that dryers, air dischargers or guide rollers and their tension are often adjusted manually and according to the experience and individual assessment of an operator of the facility, for example via a control panel. Reproducible control is often not available.

The disadvantage is that this can result in a relatively large amount of waste, in particular in applications where there is a strong need for the size of the surface to be printed to match the size of the printed decorative pattern, if, for example, length and/or width values cannot be maintained. Such an application is, for example, the production of laminate panels, which normally feature a core made of a wood-based material panel. A printed paper is applied to this core, the surface of which features a decorative pattern. Usually, a structure is imprinted or pressed into the surface of a laminate panel produced in this way, said structure preferably being synchronized with the decorative pattern printed on the surface of the paper. If the printed decorative pattern depicts a wood grain, for example, this wood grain is taken up in the corresponding structure and the haptic impression of the panel compared with a real wood panel. If this results in deviations between the dimensions of the decorative pattern and the dimensions of the structure, it is immediately apparent to the observer and such a panel must be discarded as waste.

### SUMMARY OF INVENTION

The present invention therefore aims to further develop the method for printing a surface of a paper in such a way that less waste is produced.

The invention solves the addressed task by way of a method according to the preamble of claim 1, which comprises the following steps:
a) providing an unprinted base paper,
b) applying a primer to the surface of the unprinted base paper,
c) printing at least one grid marking and preferably at least one decorative pattern onto the primer-coated base paper, thereby obtaining a printed base paper,
d) detecting a grid spacing between at least two points of the grid marking of the printed base paper to determine an actual state of the printed base paper,
e) comparing the detected grid spacing of the grid marking of the printed base paper according to the actual state with a grid spacing digitally stored as a target state for the printed decorative pattern,
f1) amending the stored target grid spacing on the basis of the comparison by creating an amended target grid spacing and a decorative pattern amended therewith and/or
f2) amending at least one process parameter for controlling the application of the primer and/or the printing of the grid marking and/or the drying until a pre-determined criterion is met.

In the first step of the method, the unprinted base is provided. It is preferably not coated with a resin. The second step of the method comprises the application of the primer to the unprinted base paper. This can also be referred to as a primer layer. The base paper is then referred to as primed base paper. It is still not coated with a resin. In step c) of the method, a grid marking is applied to the primer. For example, it is printed onto the paper to be printed, for which the digital printing facility comprises at least one printing unit. This preferably has a plurality of printing heads with which the decorative pattern and the at least one grid marking are printed. The grid marking is preferably designed in such a way that it can be detected and read by a machine, but is not visible to the human eye. According to the invention, the grid marking is printed with part of the decorative pattern or the whole decorative pattern. The paper is then a non-resined, primed and printed base paper.

In a further step of the method, a grid spacing of the grid marking of the printed base paper is then detected, which extends between two points of the grid marking. The points do not have to be punctiform or even just circular printed points; rather, they can be any points of the grid marking that are identifiable. The grid spacing preferably extends along the running direction, i.e., the direction of transport of the paper through the digital printing facility, or transversely to this running direction. However, the grid spacing may also extend along any other direction.

This grid spacing is detected by detecting and measuring at least the part of the surface of the paper that features the grid marking by means of a corresponding sensor. Depending on the grid marking used, different sensors may be deployed. In a preferred embodiment, the grid marking is printed onto the surface of the paper to be printed. This is preferably done with an ink of a color that is also contained in the decorative pattern to be printed later, so that the grid marking can no longer be detected by the observer after the decorative pattern has been printed, since it has either become part of the decorative pattern or has preferably been covered by the decorative pattern. Particularly in the latter case, the grid marking can also be printed in a color that is not contained in the decorative pattern. Alternatively, or additionally, the grid marking is printed in a color that is invisible to the human eye, but can be detected, for example, by an infrared camera, which in this case is preferably used as a sensor. The infrared image then shows the applied grid marking and the grid spacing can be determined. This advantage of this type of grid marking is that the grid marking cannot interfere with the subsequent decorative pattern and be conspicuous. It can also be advantageous to use a color that can be made to glow, for example, by irradiation with electromagnetic radiation, such as a color that fluoresces under black light, i.e., UV light. For such a grid marking, it is usually necessary to use an additional printing unit, since a conventional printing unit of a digital printing facility contains four different colors: cyan, magenta, yellow and black. The amount of equipment required for the digital printing facility is thus smaller when a grid marking is applied at the same time as the decorative pattern, wherein said grid marking is invisible to the human eye but can be read by a machine and the information contained therein can be detected and further processed.

The grid spacing determined in this manner determines the actual state of the printed base paper. It is not absolutely essential, but advantageous, to detect or even evaluate or save parameters of the printed base paper, such as the moisture of the paper, in the method described here.

The actual state determined in this manner, i.e., the detected grid spacing, is compared with a target state. This refers to a grid spacing for the decorative pattern after it has been printed. It is preferably stored digitally, for example in an electronic memory, which can be accessed by an electric control unit, especially an electronic data processing device. The target state, i.e., the grid spacing of the digital decorative pattern, extends between two points of the decorative pattern. In this case, the decorative pattern has been printed onto the surface of the paper. The target state is determined in the digital template of the decorative pattern in that the grid marking underlies the decorative pattern. The grid marking is stored with the decorative pattern in the electric control unit of the facility, for example an electronic data processing device. They are connected to each other. The stored data form the target value with which the measured actual value is compared. In the event of a deviation, either the target value, i.e., the digital print template, can be amended and adjusted, or the actual value can be influenced by setting a print parameter. The method is carried out until the predetermined criterion is met. Preferably, the actual value is determined by means of the printed grid marking and the target value by means of the digitally stored grid marking. The printed grid marking is preferably embedded in the printed decorative pattern and the stored grid marking connected to the stored decorative pattern.

To ensure that the decorative pattern to be printed fits onto the paper as well as possible and further processing can be achieved effectively, quickly, safely and to a high quality, a predetermined criterion must be met. Criteria of various type and design are conceivable, which will be described hereinafter. If the criterion is not met, the grid spacing of the digital template, i.e., the target state, hereinafter referred to as the target grid spacing, is given in step f1) of the method and/or the detected grid spacing, i.e., the actual state, is adjusted in step f2) of the method.

If in step f1) the target grid spacing, i.e., the target state, is amended, it means that the distance between the at least two points of the decorative pattern is adjusted and amended. As a result, it is possible, for example, to change the dimensions of the decorative pattern and to adjust the dimensions of the printed base paper that are known from or at least can be calculated or estimated based on the detected grid spacing. To this end, it is not necessary, but advantageous, if these dimensions are actually determined. The decorative pattern amended in this manner is printed onto the printed base paper.

If, due to the result of the comparison, the grid spacing, i.e., the actual state, is to be adjusted, for example in step f2) of the method, the paper is dried by means of the at least one dryer to change the grid spacing. This reduces the moisture content and the change in dimension, caused in particular by the moisture in the paper, i.e., the wet expansion of the paper, is reduced. Preferably, the digital printing facility has at least one electric control unit, especially an electronic data processing device, which is configured to determine the grid spacing from the sensor data and the target grid spacing from the decorative pattern, and to conduct the comparison. It can also check the result of the comparison to determine whether the predetermined criterion has been met., or additionally, at least one process parameter of the primer application unit can also be adjusted. However, this change only comes into effect when printing the respective next decorative pattern.

In an alternative embodiment, the invention solves the addressed task by way of a method according to the preamble of claim 2, which comprises the following steps:
A) providing a base paper coated with a primer,
B) printing at least one grid marking and least one decorative pattern onto the primer-coated base paper, thereby obtaining a printed base paper,
C) detecting a grid spacing between at least two points of the grid marking of the printed base paper to determine an actual state of the printed base paper,
D) comparing the detected grid spacing of the grid marking of the printed base paper according to the actual state with a grid spacing digitally stored as a target state for the printed decorative pattern,
E1) amending the stored target grid spacing on the basis of the comparison by creating an amended target grid spacing and a decorative pattern amended therewith and/or
E2) amending at least one process parameter for controlling the application of the primer and/or the printing of the grid marking and/or the drying until a predetermined criterion is met.

In this case, for example, a base paper already coated with a primer is purchased and added to the method. Steps B) to E2) of the method correspond to steps c) to f2). The same applies for steps B) to E2).

The base paper is preferably not coated with a resin and is also preferably unprinted before the primer is applied.

Preferably, the at least one process parameter of the digital printing facility is a process parameter of the primer application unit and/or the dryer.

In addition, the electric control unit is preferably configured to control the at least one dryer and/or the at least one primer application unit. In doing so, it preferably accesses data stored in an electronic memory, from which it can be determined from empirical values or experimentally how strongly the paper must be dried by means of the at least one dryer in order to cause a certain dimensional change and thus a change in the grid spacing. A functional correlation or a table of values from which this can be taken preferably exists for different types of base paper, different decorative patterns, different coatings and applications of the paper to be printed. Preferably, all of these functional correlations or tables of values are stored in the electronic memory. Via an input device, such as a control panel, the corresponding parameters are adjusted and thus communicated to the electric control unit. The data processing device then accesses the corresponding data in the electronic memory. Alternatively, or additionally, the device has multiple dryer units or at least the possibility to used one dryer unit multiple times. First of all, the dryer is preferably used to dry the paper to be printed. Preferably, the grid spacing, i.e., the actual state, is subsequently detected and compared with the corresponding target grid spacing. If the pre-determined criterion has still not been met, the process parameter of the dryer is adjusted, for example, and the next repeat pattern processed with the adjusted drying until the pre-determined criterion is met. The detected grid spacing is compared with the target grid spacing.

In a preferred embodiment, the target grid spacing is amended by elongating or compressing at least part of the decorative pattern, preferably the whole decorative pattern. This is especially advantageous if, for example, the expansion of the paper to be printed is so great that the at least one available dryer is not enough to dry the paper to compensate for the expansion.

Preferably, the predetermined criterion is met when the difference between the detected grid spacing and the target state is below a predetermined limit value. To this end, it is practical if the two points between which the grid spacing is detected correspond to the points at which the two points are to be applied between which the target state is determined. In this case, the grid spacing should correspond to the length of the target state as closely as possible. The predetermined limit value, which can be, for example, at most 1 cm, preferably at most 5 mm, especially preferably at most 1 mm, depends on the necessary tolerance and the application for which the printed paper is to be used. Preferably, the predetermined limit value depends on the length of the grid spacing and/or the target grid spacing. The larger the grid spacing and/or the target grid spacing, the higher the tolerance, i.e., the predetermined limit value, can be.

Preferably, the predetermined criterion is met when the ratio of the detected grid spacing and the target state lies within a predetermined range. This means that the ratio is greater than a predetermined lower limit value and smaller than a pre-determined upper limit value. As soon as the ratio of the two values lies outside of this range, the actual state and/or the target state are adjusted accordingly.

This selection of the criterion is advantageous, for example, if the two points between which the grid spacing is detected do not correspond to the points at which the points are to be applied between which the target state is determined. For example, the points can be selected in such a way that the detected grid spacing should be as close as possible to twice the size of the target grid spacing, i.e., the target state. If the ratio between the two values is not exactly 2, but deviates slightly from this value, the predetermined criterion is possibly not met. For example, the upper limit value may be at most 2.1, preferably 2.05, especially preferably 2.01, and the lower limit value at least 1.9, preferably at least 1.95, especially preferably at least 1.99. Depending on the selected grid spacing and the target state, other values may also be practical and advantageous.

Advantageously, multiple grid spacings of the printed base paper are detected and compared with multiple detected target states. In this case, the detected grid spacings and/or the target grid spacings, i.e., the target states, preferably extend in at least two linearly independent, particularly preferably perpendicular, directions. In a preferred embodiment, one of the detected grid spacings is compared with one of the target states in each case. In the process, different predetermined criteria can be used for each comparison. The use of multiple grid spacings and multiple target grid spacings is particularly beneficial when the anticipated expansion of the paper to be printed is inhomogeneous. This is the case, for example, when a primer coating or color-receiving layer or even a previously applied decorative pattern or part of the decorative pattern is applied in an inhomogeneous manner, i.e., with an application amount of primer, ink or other liquid that varies locally. This may result in certain areas to which a lot of liquid is applied, for example, exhibiting a high level of moisture and thus a high wet expansion, while other areas to which, for example, little fluid is applied, exhibit a low level of moisture and thus a low wet expansion.

The actual state and/or the target state are preferably amended depending on location. This renders it possible to react to the different results of the various comparisons, during which in each case a detected grid spacing is compared with one of the target states. While the electric control unit for this case is preferably configured to compress and/or elongate different areas and parts of the decorative pattern to different degrees, changing the detected grid spacing requires, for example, location-depending drying. For this purpose, a modular dryer can be used that comprises multiple individual dryer elements. The electric control unit is then preferably configured to control the individual dryer elements and, for example, to operate them for different lengths of time and at different intensities, thus drying different areas of the surface of the paper to be printed to different degrees.

Advantageously, the grid marking features grid points arranged, preferably equidistantly, along multiple lines, the lines preferably extending in two linearly independent, preferably perpendicular, directions. In another embodiment, the grid marking is a two-dimensional marking which is, for example, a frequency-modulated grid marking. Alternatively, an amplitude-modulated grid marking can also be used.

The grid marking is preferably integrated into the decorative pattern and is macroscopically invisible.

Preferably, the grid marking is contained in the final printed decorative pattern, but is imperceptible to the human eye. As a result, it cannot have an effect that disrupts the visual impression, but is available in further processing steps. To this end, it is advantageous if the grid marking contains information which, for example, enable product tracking and, for example, indicate the originator, place of printing, a time of production or other information. This is of particular interest in terms of quality assurance and potential liability. Tools of a dividing saw and/or a profiling machine, but also units for sealing or painting edges of a panel on whose carrier plate the printed paper is located, especially in the form of a decorative paper, can also be adjusted using the grid marking that is visible to the sensors. In the context of the present invention, a decorative paper is understood to mean a decorated base paper impregnated with synthetic resin that can be pressed with a carrier to form a laminate with said carrier, for example an HDF panel.

In subsequent work steps, the grid marking can be used, for example, to align the various elements to be pressed together, such as the printed paper and a carrier plate, in a pressing tool, such as a press belt or press plate. In this case, the paper has preferably already been impregnated and, where applicable, cut to size. It is then a decorative paper.

The invention also solves the addressed task by way of a digital printing facility for carrying out a method according to one of the embodiments described here. The device has at least one primer application unit for applying a color-receiving layer, at least one printing unit for printing the decorative pattern onto the applied color-receiving layer, and at least one dryer that is configured to dry at least part of the surface of the paper to be printed, but preferably the entire surface of the paper to be printed, after the color-receiving layer and/or the decorative pattern or a part thereof has been applied. Particularly preferably, the at least one dryer features multiple dryer elements that are configured in each case to dry part of the surface of the paper to be printed. The dryer elements can preferably be controlled individually and/or in groups by the electric control unit. As a result, the drying power of each individual dryer element of the dryer elements can be adjusted separately and independently of other dryer elements. Preferably, the digital printing facility has multiple dryers arranged one behind the other in the running direction of the paper to be printed. Particularly preferably, a printing unit is located between at least two of the dryers.

The digital printing facility comprises at least one printing unit, preferably multiple printing units, each of which is configured to print the surface of a paper. This can be achieved by applying a primer coating or a primer, or by applying the decorative pattern.

In addition, the facility preferably has at least one sensor for detecting the grid marking. Preferably, such a sensor is located upstream of every dryer. The measurement data detected by the respective sensor are transmitted to the electric control unit, which uses them to detect the grid spacing. If the actual state is to be adjusted due to the result of the comparison, it is advantageous if there is a dryer downstream of the sensor in the running direction of the paper. On the other, if only the target state is to be adjusted, it is enough if a printing unit is located downstream of the sensor.

A grid marking of the type described here can also be used to optimize further processing steps during the production of laminate and the subsequent processing to produce laminate panels. Such panels are preferably suitable for floating installations, in particular for installations in which glue is not used.

The grid marking preferably enables:
product tracking for the purposes of traceability, for example for product liability reasons, and/or
proof of origin concerning the production line and manufacturer from which a decorative paper originates,

and/or can preferably be used:
as a basis for aligning decorative paper and carrier plate with a structure on a pressing tool, such as a press belt or press plate, particularly for so-called embossed-in-register surfaces with structures that run at least in part synchronously to the decorative pattern,
as a basis for aligning tools of a dividing saw used to cut out panels from a large-scale laminate,
as a basis for aligning tools of a profiling machine used to process connection profiles and interlocking elements at the lateral edges of the panels, so-called tongue and groove connections, for example in the form of so-called click connections, and/or
as a basis for aligning units for sealing and/or painting the edges of the panels.

### BRIEF DESCRIPTION OF DRAWINGS

In the following, an embodiment example of the invention will be explained in more detail with the aid of the accompanying figures. The Figures show:

FIG. 1 shows a schematic top view of a digital printing facility and

FIG. 2 shows an enlarged section from a top view of a facility according to an embodiment example of the present invention.

### DETAILED DESCRIPTION

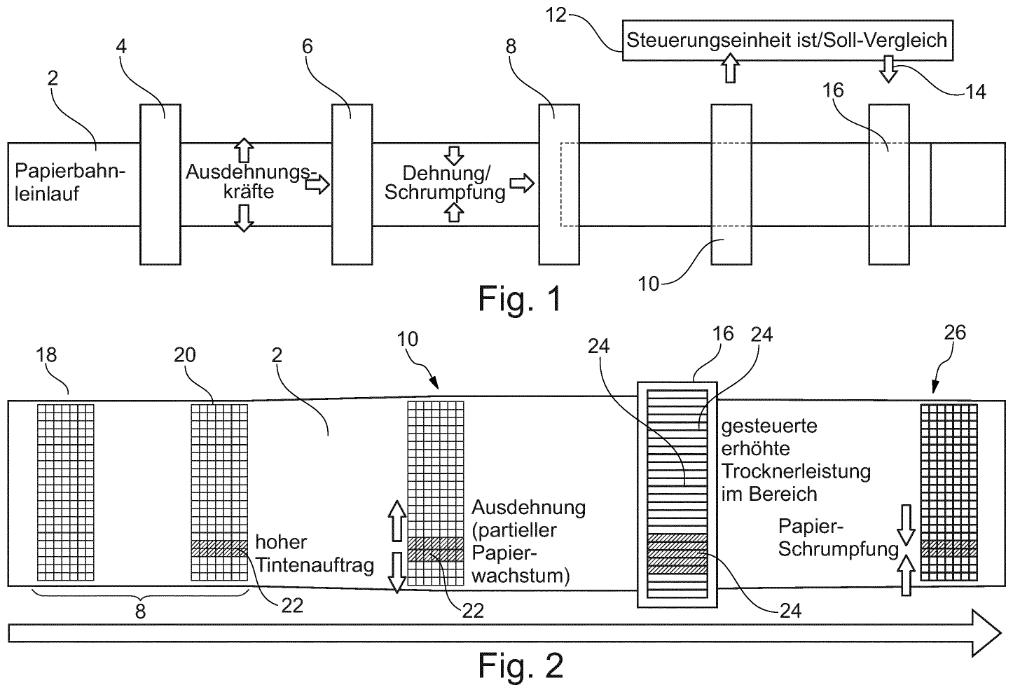

FIG. 1 shows a highly schematic top view of a digital printing facility with which a method of the type described here can be carried out. In the embodiment example shown, the unprinted base paper 2 to be printed is provided in the form of a paper roll, especially an infinite paper web, and in the embodiment example shown in FIG. 1, is transported from left to right through the printing facility. The running direction therefore also runs from left to right. The facility has a first printing unit 4, which is configured to apply a first application to the paper web to be printed. This preferably refers to a primer coating, which is preferably applied in a homogenous manner. The first printing unit 4 is a primer application unit. Consequently, in the first printing unit 4 liquid is applied to the paper 2, thereby changing the moisture level of the paper 2. Once the paper 2 has left the first printing unit 4 to the right, a change in the expansion of the paper 2 occurs. On the one hand, due to the tension of the paper web 2 that has to be maintained for printing, expansions occur in the running direction. On the other hand, an expansion also occurs perpendicular to the running direction, as the moisture in the paper has increased and the paper has therefore expanded.

As such, the paper 2 then moves into the first dryer 6, in which the paper 2 is dried. This causes the paper to shrink both in the running direction and transversely to the running direction. Dried in this manner, the paper 2 reaches a second printing unit 8 which, in the present embodiment example, is used to print a marking and the decorative pattern onto the upper side of the paper 2. The decorative pattern is usually inhomogeneous, so that in the second printing unit 8 an inhomogeneous quantity of liquid is applied to the upper side of the paper 2. This potentially results in an inhomogeneous expansion of the printed paper 2. The base paper printed in this way then passes through a detection system 10, which comprises at least one sensor that can detect a grid marking applied to the upper side of the paper. The data determined in this way are fed to an electric control unit 12, which determines the detected grid spacing from said data. Inside the electric control unit, this detected grid spacing is compared with a target grid spacing, i.e., the target state, which corresponds to a target size in the embodiment example shown. As previously explained, applying the ink in the second printing unit 8 causes an expansion of the paper, so that the applied decorative pattern also expands. Particularly in the event that the printed paper is to be further processed, as is the case, for example, in the production of wood-based material panels, it is important that the printed paper leaving the facility exhibits the expected and required dimensions as precisely as possible. The electric control unit therefore transfers control signals 14 to a second dryer 16. This second dryer 16 dries the paper 2, so that it has the required dimensions.

FIG. 2 shows an enlarged section from the facility in a separate representation. The grid marking is applied in a target specification 18. To this end, either a first part of the second printing unit 8 or a separate printing unit is used. The actual decorative pattern printing 20 then also occurs in the second printing unit 8. In the process, a sub-area 22 of the upper side of the paper 2 to be printed is subjected to particularly heavy and intense printing. This means that a comparatively large amount of ink is applied, so that the moisture in the paper in this area significantly increases. The sub-area 22 therefore expands more than the remaining printed area of the surface of the paper. This is detected in the detection system 10 by means of the at least one sensor. The control signals 14 transmitted by the electric control unit 12 are transmitted to the second dryer 16, which in the example embodiment shown comprises a series of individual dryer elements 24 that are arranged next to each other transversely to the running direction of the paper, which also extends from left to right in FIG. 2. The dryer elements 24, which are located in the area of the sub-area 22 and are configured to dry it, are controlled differently to the remaining dryer elements 24, namely in such a way that they have an increased drying power, so that the paper 2 in sub-area 22 is dried more intensively than in the remaining part. This causes the paper to shrink and produces the desired result 26.

1. A method for printing a decorative pattern onto a surface of a paper by means of a digital printing facility that comprises:
at least one primer application unit for applying a primer,
at least one printing unit for printing the decorative pattern onto the applied primer, and
at least one dryer for drying at least one part of the paper after the primer and/or decorative pattern has been applied,
the method comprising:
a) providing an unprinted base paper,
b) applying a primer to the surface of the unprinted base paper,
c) printing at least one grid marking and at least one decorative pattern onto the primer-coated base paper, thereby obtaining a printed base paper,
d) detecting a grid spacing between at least two points of the grid marking of the printed base paper to determine an actual state of the printed base paper,
e) comparing the detected grid spacing of the grid marking of the printed base paper according to the actual state with a grid spacing digitally stored as a target state for the printed decorative pattern,
f1) amending the stored target grid spacing on the basis of the comparison by creating an amended target grid spacing and a decorative pattern amended therewith and/or
f2) amending at least one process parameter for controlling the application of the primer and/or the printing of the grid marking and/or the drying until a predetermined criterion is met.

2. A method for printing a decorative pattern onto a surface of a paper by a digital printing facility that comprises:
at least one printing unit for printing the decorative pattern onto the applied primer, and
at least one dryer for drying at least one part of the paper after the primer and/or decorative pattern has been applied,
the method comprising:
A) providing a base paper coated with a primer,
B) printing at least one grid marking and at least one decorative pattern onto the primer-coated base paper, thereby obtaining a printed base paper,
C) detecting a grid spacing between at least two points of the grid marking of the printed base paper to determine an actual state of the printed base paper,
D) comparing the detected grid spacing of the grid marking of the printed base paper according to the actual state with a grid spacing digitally stored as a target state for the printed decorative pattern,
E1) amending the stored target grid spacing on the basis of the comparison by creating an amended target grid spacing and a decorative pattern amended therewith and/or
E2) amending at least one process parameter for controlling the application of the primer and/or the printing of the grid marking and/or the drying until a predetermined criterion is met.

3. The method according to claim 2, wherein the at least one process parameter of the digital printing facility is a process parameter of the primer application unit and/or the dryer.

4. The method according to claim 1, wherein to amend the grid spacing of the printed base paper, the printed base paper is dried by at least one dryer.

5. The method according to claim 1, wherein the target grid spacing is amended by elongating or compressing at least part of the decorative pattern.

6. The method according to claim 1, wherein the predetermined criterion is met when a difference between the detected grid spacing and the target state is below a predetermined limit value.

7. The method according to claim 1, wherein the predetermined criterion is met when a ratio of the detected grid spacing and the target state lies within a predetermined range.

8. The method according to claim 1, wherein multiple grid spacings of the printed base paper are detected and compared with multiple target states, the detected grid spacings and/or the target states extending in at least two linearly independent directions.

9. The method according to claim 8, wherein the grid spacing of the printed base paper and/or the target state is amended depending on location.

10. The method according to claim 1, wherein the grid marking features grid points arranged along multiple lines.

11. The method according to claim 1, wherein the grid marking is a frequency-modulated grid marking.

12. The method according to claim 1, wherein the grid marking is integrated into the decorative pattern and is macroscopically invisible.

13. A digital printing facility for carrying out a method according to claim 1.

14. The method according to claim 5, wherein the target grid spacing is amended by elongating or compressing the whole decorative pattern.

15. The method according to claim 8, wherein the at least two linearly independent directions comprise perpendicular directions.

16. The method according to claim 10, wherein the grid marking features grid points arranged equidistantly along the multiple lines.

17. The method according to claim 16, wherein the multiple lines extend in two linearly independent directions.

18. The method according to claim 17, wherein two linearly independent directions comprise perpendicular directions.
